(19) United States
(12) Patent Application Publication
(10) Pub. No.: US 2005/0025449 A1
(43) Pub. Date: Feb. 3, 2005

(54) Methods and structures for testing optical subassemblies at higher and lower temperatures

(76) Inventors: John C. Dirkson, Santa Clara, CA (US); James Douma, Monrovia, CA (US); Rudolf J. Hofmeister, Sunnyvale, CA (US); Samantha R. Bench, Whitefish, MT (US); Dev E. Kumar, San Jose, CA (US)

Correspondence Address: WORKMAN NYDEGGER (F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 10/929,944

(22) Filed: Aug. 30, 2004

Related U.S. Application Data
(63) Continuation-in-part of application No. 10/695,203, filed on Oct. 28, 2003.
(60) Provisional application No. 60/425,002, filed on Nov. 8, 2002.

(51) Int. Cl. G02B 6/00

(52) U.S. Cl. 385/147

(57) ABSTRACT

An assembly and method for testing an optical subassembly by locally heating or cooling the optical subassembly. Locally heating or cooling the optical subassembly can include using a thermal transfer assembly. The thermal transfer assembly can include a thermoelectric cooler. A clamping assembly is provided to place the optical subassembly in electrical communication with a testing assembly. The thermal transfer assembly can be associated with the clamping assembly. After achieving the desired temperature, a data stream is transmitted through the optical subassembly and evaluated for compliance.

### CROSS-REFERENCE TO RELATED APPLICATIONS

This application is a continuation-in-part application of U.S. patent application Ser. No. 10/695,203, filed Oct. 28, 2003, which claims priority to U.S. Provisional Patent Application Ser. No. 60/425,002, filed Nov. 8, 2002, both of which are entitled “OPTICAL SUBASSEMBLY TESTER AND TESTING METHOD,” and both of which applications are incorporated herein by reference in their entireties.

### BACKGROUND OF THE INVENTION

1. Field of the Invention

The present invention relates generally to the field of fiber optic devices. More particularly, the present invention relates to methods and structures for testing the optical component of an optoelectronic device at higher or lower temperatures before attaching the optical component to the electrical components.

2. Relevant Technology

Optoelectronic devices, such as transceivers and transponders, are devices that are capable of performing two functions. First, a transmitting portion of an optoelectronic device receives electrical signals, translates the electrical signals to optical signals, and then transmits the optical signals. Second, a receiving portion of an optoelectronic device receives optical signals, translates the optical signals to electrical signals, and then transmits the electrical signals. Note that an optoelectronic device may have the capability to transmit, receive, or both, similar to that found in a transceiver or transponder.

In the manufacture of optoelectronic devices, each device is tested to ensure that it functions properly before selling the device to a customer. Since optoelectronic devices operate in a variety of environments (with respect to temperature, supply voltage, etc.), the devices are preferably tested under conditions similar to those found in the various operating environments that the optoelectronic device will encounter.

Testing optoelectronic devices has, however, proven to be a costly activity. This cost is related to the fact that optoelectronic devices are not readily disassembled or repaired once its components have been assembled. Optoelectronic devices are composed of an electrical component and a single or pair of optical components. The electrical component transmits and receives electrical signals, whereas the optical components transmit and receive optical signals, respectively. An optoelectronic device will malfunction if the electrical component, either of the optical components, or their connection malfunctions.

Typically, an optoelectronic device is tested after it has been completely assembled. When an optoelectronic device is found to be malfunctioning, disassembling the optoelectronic device is time consuming, and thus expensive, and may render unusable the device's electrical components, optical components or both. Further, for some types of malfunctions, testing the optoelectronic device as a whole makes it difficult to determine which component of the device is malfunctioning.

Additionally, when optical components of optoelectronic devices are tested before assembling with corresponding electrical components, the optoelectronic device's components have conventionally been bonded to the testing equipment in an almost non-reversible manner, e.g., using soldering, conductive epoxy, etc. This has been required to provide a strong connection in order to test high-speed (e.g., 10 Gb/s) protocols and, more importantly, to guarantee good signal integrity. However, semi-permanently bonding the optical component to the testing equipment requires additional process steps and may damage the electrical connective system (e.g., leads or flexible circuit). Because of this, it is usually favored to test the optoelectronic device after the optical and electronic components have been assembled together.

In addition, an important reason for testing optical components of optoelectronic devices before the optoelectronic device is completely assembled is that when fully assembled, it takes a long time to characterize an optoelectronic device, such as a transceiver. Such characterization is important to ensure reliability in the optoelectronic device. Characterization of the optical components and electrical components can be more easily, quickly and reliably done as individual pieces before the optoelectronic device is filly assembled. Because optoelectronic devices often operate at data rates on the order of or in excess of billions of bits per second (i.e., Gb/s), the malfunction of such an optoelectronic device, even momentarily, is unacceptable.

Finally, an optoelectronic device often fails at the extreme low or extreme high temperatures of its operating range. Currently, the method for assessing the operation of an optoelectronic device at temperatures or lower higher than that of ambient temperature is to place the optoelectronic device (i.e., including both the optical components and electrical components) in a chamber such as an oven or refrigerator to heat or cool the optoelectronic device. However, these temperature chambers can be large and produces complications when connecting an oven with a testing assembly and/or host computer. In addition, the batch nature of this process slows down testing and, as such, the potential yield.

### SUMMARY OF THE INVENTION

An optical component or optical subassembly (“OSA”), of an optoelectronic device is tested separately from the device's electrical components. Manufacturing and testing costs are lowered by detecting malfunctioning optical components prior to their assembly with the device's electrical components. The systems and methods of the present invention increase the efficiency and reliability of producing optoelectronic devices by reducing waste and decreasing costs on the front end by ensuring the optical subassemblies are functional and efficient before connecting them to the electrical components.

In one aspect of the invention, the optical component is tested at higher and/or lower temperatures than ambient temperature. One method of testing an optical subassembly (“OSA”) of an optoelectronic device, comprises identifying a testing assembly comprising a base assembly, the base assembly being associated with a thermal transfer assembly; identifying an optical subassembly; temporarily electrically coupling the base assembly and the optical subassembly; temporarily thermally-coupling the thermal transfer assembly and the optical subassembly; transferring heat between the thermal transfer assembly and the optical subassembly so as to adjust the temperature of the optical subassembly while substantially maintaining the temperature of the base assembly; and testing the optical subassembly at the adjusted temperature for a first operating parameter.

Temporarily thermally coupling the thermal transfer assembly and the optical subassembly can include maximizing the heat flow between the thermal transfer assembly and the optical subassembly. The method can include positioning the base assembly with respect to the optical subassembly so as to minimize the heat flow between the base assembly and the optical subassembly. In addition, the method can include positioning the thermal transfer assembly with respect to the base assembly so as to minimize the heat flow between the thermal transfer assembly the base assembly.

In another aspect of the invention, at least a portion of the optical subassembly is locally heated or locally cooled so that heating or cooling of surrounding structures is minimal. In one embodiment, the optical subassembly is heated or cooled higher or lower than ambient temperature. For example, the optical subassembly can be heated to 70° C. or cooled to 0° C., heated to 125° C. or cooled to negative (−)25° C., or heated to 200° C. or cooled to negative (−)40° C.

According to another aspect of the invention, a testing assembly is configured to evaluate an optical subassembly before the optical subassembly is connected to electrical components of an optoelectronic device, the assembly comprising a base member; a test circuit disposed on the base member; means for temporarily placing the optical subassembly in electrical communication with the test circuit; a thermal transfer assembly associated with the base member, the thermal transfer assembly configured to adjust the temperature of a portion of the optical subassembly, and means for temporarily placing the optical subassembly in thermal communication with the thermal transfer assembly.

The means for temporarily placing the optical subassembly in temporary electrical connection with the electrical interface can comprise a clamping assembly pivotably mounted to the base member. The means for temporarily placing the optical subassembly in thermal communication with the thermal transfer assembly can include a thermoelectric cooler connected to the clamping assembly.

In yet another aspect of the invention, the thermal transfer assembly includes a thermoelectric cooler (TEC). The TEC can be configured to be placed in thermal communication with the optical subassembly. In one embodiment, the TEC can be associated with a clamping assembly on the testing assembly so that when the temporary connection is formed between the clamping assembly and the optical subassembly, the TEC is temporarily thermally coupled to the optical subassembly so as to adjust the temperature of a portion of the optical subassembly. The thermal transfer assembly can include a heat sink.

In yet another aspect of the invention, a testing assembly is configured to evaluate an optical subassembly before the optical subassembly is connected to the electrical components of the optoelectronic device, the assembly comprising a base member; a test circuit disposed on the base member;a clamping assembly mounted to the base member, the clamping assembly configured to place the optical subassembly in temporary electrical communication with the test circuit; and a thermal transfer assembly mounted to the clamping assembly, the thermal transfer assembly configured to be temporarily thermally coupled to an optical subassembly and to temporarily adjust the temperature of a portion of the optical subassembly.

In still another embodiment, the optical subassemblies can be locally heated or cooled by other methods other than using a thermal transfer assembly. For example, the optical subassemblies can be operated to self-generate heat.

These and other advantages and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings, in which:

FIG. 1 illustrates a block diagram of an optical subassembly tester in accordance with an embodiment of the present invention;

FIG. 2 is a block diagram of an optical subassembly tester with a TOSA in accordance with an embodiment of the present invention;

FIG. 3 is a block diagram of an optical subassembly tester with a ROSA in accordance with an embodiment of the present invention;

FIG. 4 is a block diagram of an optical subassembly tester in accordance with an embodiment of the present invention;

FIG. 5 is a perspective drawing of another embodiment of the testing assembly of the present invention, illustrating a dual testing configuration;

FIG. 6A is a schematic drawing of the clamp assembly of an optical subassembly tester in the open position in accordance with an embodiment of the invention;

FIG. 6B is a schematic drawing of the clamp assembly of an optical subassembly tester in the closed position in accordance with an embodiment of the invention;

FIG. 6C is a schematic drawing of the clamp assembly of an optical subassembly tester in the unengaged position in accordance with an embodiment of the invention;

FIG. 6D is a schematic drawing of the clamp assembly of an optical subassembly tester in the engaged position in accordance with an embodiment of the invention;

FIG. 6E is a schematic drawing of the clamp assembly of an optical subassembly tester in the unengaged position in accordance with an embodiment of the invention;

FIG. 6F is a schematic drawing of the clamp assembly of an optical subassembly tester in the engaged position in accordance with an embodiment of the. invention;

FIG. 7 is a side plan view of the head of the clamping assembly according to the embodiment of FIG. 5; and

FIG. 8 is a flowchart of the general method in which the optical subassembly tester may be used to test the optical component of an optoelectronic

### DETAILED DESCRIPTION OF THE PREFERRED EMBODIMENTS

Embodiments of the present invention relate to systems and methods of testing the optical components of an optoelectronic device. As used herein, the term “optoelectronic device” generally includes any device which contains both optical and electrical components for receiving and/or transmitting optical and/or electrical signals. In particular, the present invention relates to testing the optical component at higher and/or lower temperatures than ambient temperature in order to ensure that the resulting optoelectronic device will be able to function at the extreme environmental temperatures that it may experience during operation. Such testing is intended to increase the yield of operable optoelectronic devices, reduce manufacturing and testing costs, and improve overall quality assurance.

As used herein, the term “optical component” and “optical subassembly” are used interchangeably to refer to the portion of the optoelectronic device that performs the optical functions. For example, the optical component can include laser diodes, VCSELs, DFBs, and Fabry-Perot lasers, avalanche photodiodes (APD), positive-intrinsic-negative photo diodes (PIN), laser emitting diodes (LEDs), and the like.

Broadly stated, methods for testing the optical component includes locally heating and/or cooling the optical component and testing the optical component before it is assembled to the electrical components which together form the optoelectronic device. As used herein, the term “locally heated” or “locally cooled” refers to heating or cooling the optical component such that the heating or cooling is maximized with respect to the optical component and minimized with respect to other areas of the testing assembly.

For example, the testing assembly may include a base structure. Locally heating or cooling the optical component provides that the optical component is heated or cooled, that the base structure remains substantially at ambient temperature. In one exemplary embodiment, when heating the optical component the base structure is thermally decoupled from the optical component being tested so that it remains at ambient temperature. At the same time, the base structure can also be thermally decoupled from the thermal transfer assembly that is heating the optical component. In this way, the heating or cooling energy is effectively directed at the optical component so that excess energy is not wasted to heat or cool parts of the testing assembly which are not required to be heated or cooled for purposes of testing the optical component. In one embodiment, to effectuate local heating or cooling, the optical component is temporarily thermally coupled with the thermal transfer assembly. The thermal transfer assembly, in turn, can be permanently or temporarily connected to an optical subassembly testing system of any design or configuration.

Embodiments of testing assemblies that can include a thermal transfer assembly for locally heating and/or cooling an optical component will now be discussed in detail. The present invention, however, is not limited to any particular embodiment of a testing assembly.

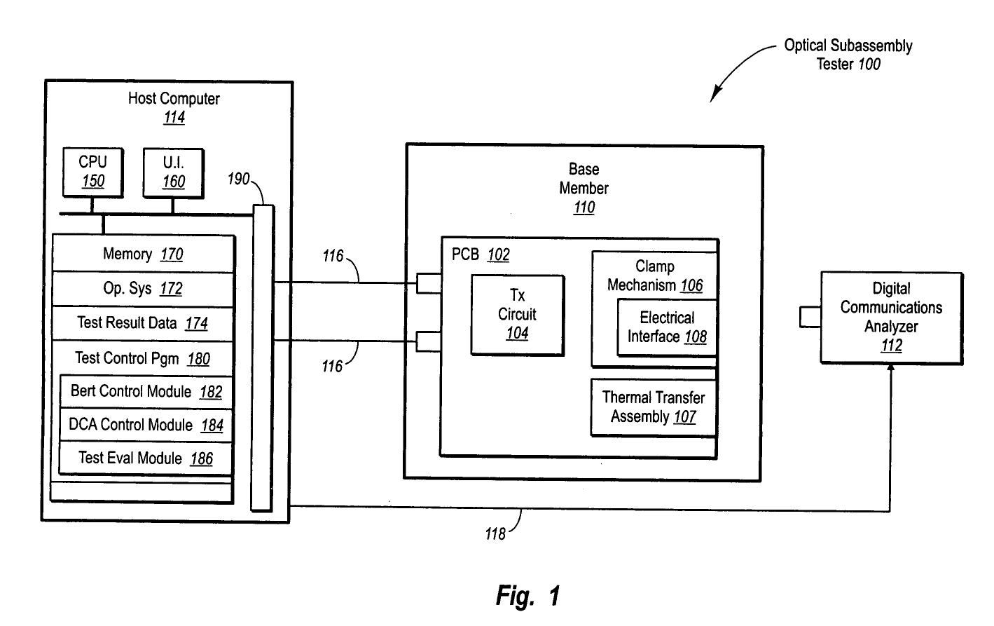

FIG. 1 is a block diagram of a system for testing an optical subassembly in accordance with an embodiment of the present invention. The optical subassembly tester 100 includes a printed circuit board (“PCB”) 102 mounted on a base member 110. A test circuit 104 is, in turn, mounted on the PCB 102. For embodiments where transmitting optical components are being tested, the test circuit 104 corresponds to suitable circuitry, represented in FIG. 1 as a Tx circuit 104. In addition, the PCB 102 includes an electrical interface 108. Although not shown, the electrical interface 108 is electrically coupled to the test circuit 104. When the test circuit 104 is electrically couple to the PCB 102, a printed circuit board assembly (PCBA) is formed.

The test circuit 104 conveys test signals between a tester (e.g., a bit error ratio tester, also sometimes referred to as a bit error rate tester), test controller or host computer 114 and an optical subassembly such as a Transmitter Optical Subassembly (“TOSA”) or Receiver Optical Subassembly (“ROSA”). Base member 110 also contains a clamp assembly 106 in association with the electrical interface 108. The clamp assembly 106 is configured to temporarily connect a portion of an optical subassembly (not shown) to the electrical interface 108. An electrical connection is thus formed at the electrical interface 108 between the optical subassembly to be tested and the test circuit 104. A tester, test controller or host computer 114 is coupled to the test circuit 104 by signal lines or a bus of signal lines 116.

The tester 100 also includes a thermal transfer assembly 107. The thermal transfer assembly 107 can be associated with the tester 100 in a variety of ways. In one embodiment, the thermal transfer assembly 107 is connected to the clamp assembly 106 so that the thermal transfer assembly can be temporarily thermally coupled with the optical subassembly (not shown). In another embodiment, the thermal transfer assembly 107 can be connected to an auxiliary member of base member 110 so that it can be selectively thermally coupled to the optical subassembly. As used herein, the term “thermal coupling” refers to both heating and/or cooling of an optical subassembly. In addition, the term “thermal coupling” does not require that the thermal transfer assembly come in actual contact with the optical subassembly, but simply requires the thermal transfer assembly to in a position such that it is thermally coupled with the optical subassembly.

The host computer 114 preferably contains a user interface 160, one or more interfaces 190 for connection to the test circuit 104, a central processing unit (“CPU”) 150 and a memory 170. The memory 170 may include high speed random access memory and may also include nonvolatile mass storage, such as one or more storage devices. The memory may include mass storage that is remotely located from the central processing unit(s). The memory preferably stores an operating system 172, a test control program 180 and test result data 174.

The operating system 172 has instructions for communicating, processing data, accessing data, storing data, searching data, etc. The test control program 180 may include a digital communications analyzer (“DCA”) control module 184, or a bit error ratio tester (“BERT”) control module 182, and a test data evaluation module 186. The test result data 174 is received from the DCA or BERT. The test control program 180 and DCA or BERT control module 184/182 include computer programs or procedures for controlling operation of the DCA 112 or BERT and for receiving test result data from the DCA or BERT. The test evaluation module 186 includes instructions for evaluating the test result data to determine whether the optical component is functioning properly.

The host computer 114 controls the function of the test circuit 104 and the optical subassembly being tested. The host computer 114 is coupled to the test circuit 104 via a bus 116. The host computer 114 transmits test data for the TOSA being tested. Specifically, the host computer 114 can be connected to a signal generating/detecting assembly (not shown) which generates test data or detects test data. The signal generating/detecting assembly would thus be disposed between the host computer 114 and transmit (Tx) or receive (Rx) circuit 104. The signal generating/detecting assembly will depend on whether the host computer is generating or detecting test signals. In configurations where the host computer 114 is generating high-speed data to test a transceiver, the signal generating/detecting assembly may be a pattern generator device. In other configurations where the host computer 114 is error-comparing the high speed data of a receiver, the signal generating/detecting assembly can be a BERT error detector having an optical signal source and a controllable attenuator. Thus, in the following discussion in which the host computer 114 is described as controlling the test signal generating or detecting, it will be appreciated that additional hardware may be used to accomplish the same.

The host computer 114 is also coupled to the DCA 112 via a bi-directional bus 118. The DCA 112 transmits test results and/or information based on data received from the TOSA to be tested during the testing process via bus 118 to the host computer 114. The host computer 114 processes, adjusts and records the settings and measurements made during the optical subassembly testing process.

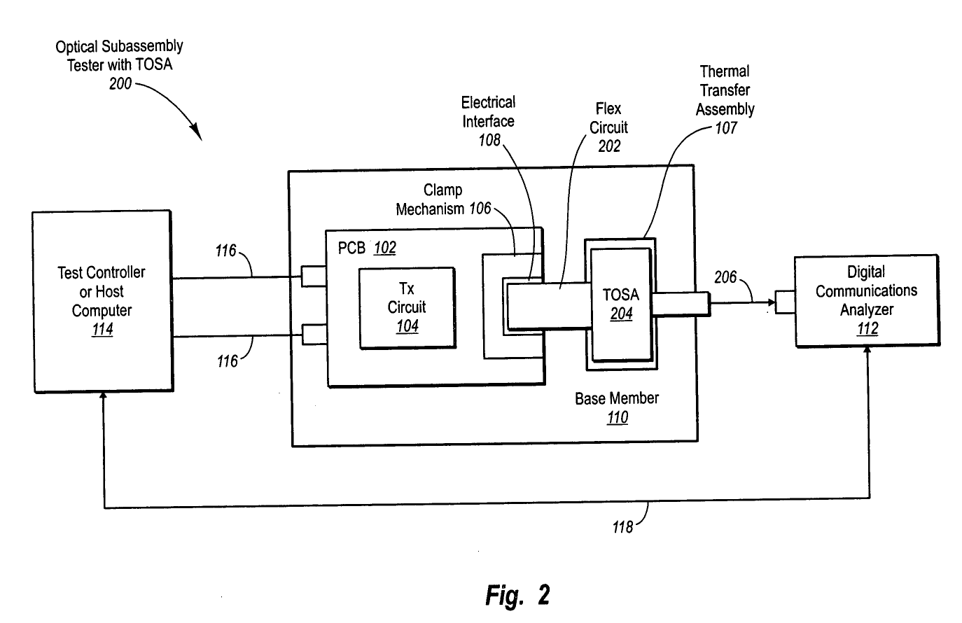

FIG. 2 is a block diagram of a system 200 for testing a TOSA 204 in accordance with an embodiment of the present invention. The configuration allows a TOSA 204 of an optoelectronic device to be tested in certain environments, using a DCA 112 to receive an optical signal from the TOSA 204. The DCA 112, the test circuit 104 and the environment in which the TOSA 204 is tested are controlled by a host computer 114.

In this embodiment, the test circuit 104 is contained in a printed circuit board (“PCB”) 102 that rests on a base member 110 of an an optical subassembly tester 200. The optical subassembly tester 200 may optionally be placed in a controlled environment test chamber. In some embodiments, the test circuit 104 is a replica of the circuitry, or a portion of the circuitry, in an optoelectronic device. Thus, the test circuit 104 may include the circuitry for biasing the TOSA 204 to be tested, circuitry for driving the TOSA with a data signal, and may further include control circuitry that receives commands from the host computer 114 via lines 116 for controlling the biasing of the TOSA 204.

The electrical receiving end of the TOSA 204 to be tested is coupled to a flexible or flex circuit 202. The coupling of the flex circuit 202 to the TOSA 204 is preferably a solder or similar high quality electrical connection, e.g., a z-axis anisotropic conductive adhesive. While a flex circuit is described as the electrical receiving end of the optical subassembly to be tested, those skilled in the art will understand that other electrical means may be provided such as various lead systems known in the art. The flex circuit 202 is connected to the test circuit 104 at an electrical interface 108 (FIG. 1) on the PCB 102 by closing a clamping assembly 106 to secure a high quality electrical connection that is temporary for purposes of conducting the test of the TOSA 204.

The DCA 112 is configured to receive test signal transmissions from the TOSA 204 via a fiber optic connection 206. The DCA 112 is connected via a bus 118 to the host computer 114 for transmitting and receiving test data and commands.

The host computer 114 controls the test data conditions as well as the DCA's 112 functioning. An electrical test signal is fed from the host computer 114 or BERT to the test circuit 104 through at least one bus 116 and to the TOSA 204 via the flex circuit 202. A resulting optical test output signal is then transmitted from the TOSA 204 through an optical fiber 206 and is received by the DCA 112 which is coupled to the host computer 114. The DCA 112 analyzes the test signal for compliance with pre-programmed operating requirements. The DCA 112 then transmits the results of its analysis to the host computer 114 for further adjustment of the control parameters if necessary. The test data results are then stored in the host computer 114 for later use. In addition, the DCA converts the optical signal it receives into a data stream that is conveyed back to the host computer 114 or BERT for comparison with the data stream transmitted to the TOSA 204.

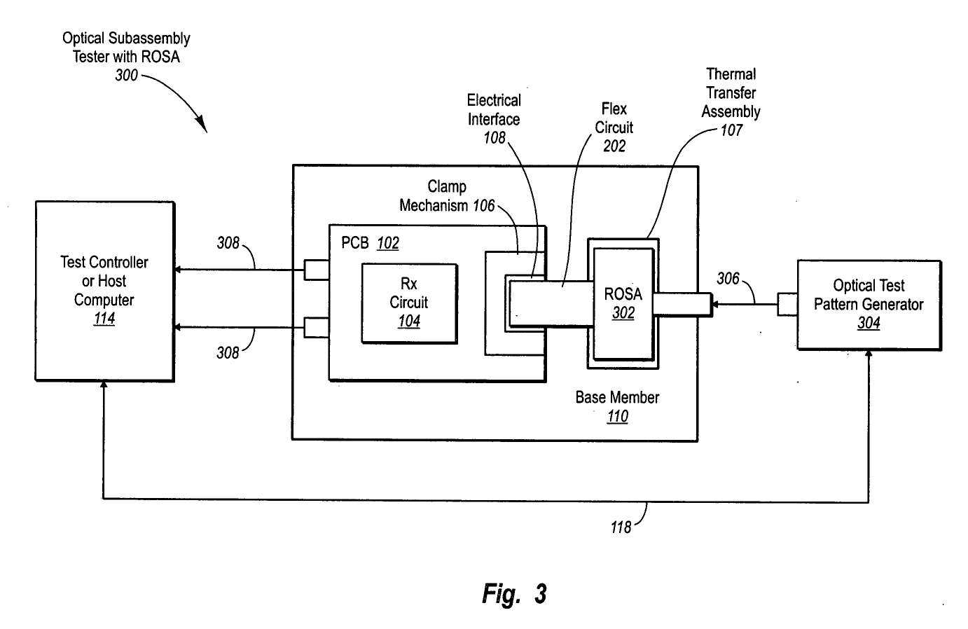

FIG. 3 is a block diagram of a system 300 for testing a ROSA 302 in accordance with an embodiment of the present invention. Unlike the testing of a TOSA, the goal of testing a ROSA is to test the ROSA's ability to convert an optical signal to an electrical signal. In embodiments where the receiving optical components of an optoelectronic device are being tested, the testing circuit 104 corresponds to suitable circuitry, represented in FIG. 3 as Rx circuit 104. The optical subassembly tester 200 may optionally be placed in a controlled environment test chamber. The test circuit 104 is connected to the host computer 114, which transmits commands to the test circuit 104 and receives test signals from the test circuit 104. The test circuit 104 is connected to the host computer 114 via one or more control buses 116.

The electrical transmitting end of the ROSA 302 to be tested is coupled to a flex circuit 202. The coupling (of the flex circuit 202 to the ROSA 302) is preferably a solder or similar high quality electrical connection. The flex circuit 202 is connected to the test circuit 104 at an electrical interface 108 (FIG. 1) on the PCB 102 by closing a clamping assembly 106 to secure a high quality electrical connection that is temporary for purposes of conducting the test of the ROSA 302.

An optical test pattern generator 304, such as a BERT having an optical transmitter at its output port, is configured to transmit test signal transmissions to the ROSA 302 via a fiber optic connection 306. The generator 304 can be substituted for the DCA 112 in FIG. 2. The optical test pattern generator 304 is connected via a bus 118 to the host computer 114 for transmitting and receiving test data and commands.

The host computer 114 controls the test data conditions as well as the optical test pattern generator's 304 functioning. An optical test signal is fed from the optical test pattern generator 304 to the ROSA 302 via the fiber optic connection 306. A resulting electrical test output signal is then transmitted from the ROSA 302 to the test circuit 104 through the flex circuit 202. The host computer 114 then receives the test output signal from the test circuit 104 via buses 308 and analyzes the test signal in conjunction with data received from the optical test pattern generator 304 for compliance with pre-programmed operating requirements. The host computer 114, based on its analysis of the test results, transmits commands to the optical test pattern generator 304 for further adjustment of the control parameters if necessary. The test data results are then stored in the host computer 114 for later use. In addition, the host computer 114 may send commands to the test circuit 104 to adjust the parameters controlling the ROSA 302 or to adjust other operating parameters of the test circuit 104.

Alternatively, analysis of the test signal for compliance with operating requirements can be done manually by viewing with a scope, such as a DCA 112, that displays the test signal. Necessary adjustments to control parameters are then communicated to the host computer 114 by the viewer until operating requirement compliance is achieved or deemed not feasible.

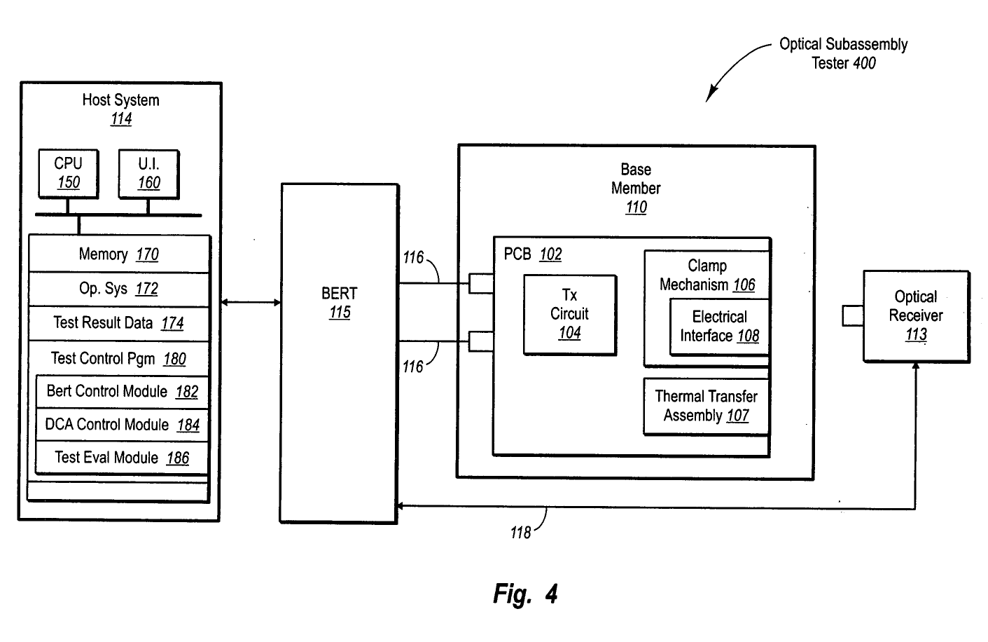

FIG. 4 is a block diagram of a system 400 similar to the system 100 shown in FIG. 1, but using a bit error ratio tester (BERT) 115 and optical receiver 113. The optical receiver 113 may be a simple optical receiver, a DCA, or both. In this embodiment, the host computer 114 controls the operation of the BERT 115, using its BERT control module 182. The BERT 115 sends test patterns to the optical subassembly (e.g., a TOSA) via the test circuit 104, and receives return data that it analyzes to determine a bit error ratio associated with the optical subassembly undergoing the testing. A similar ROSA testing system can be used to test ROSA's, by replacing the optical receiver with an optical transmitter. In ROSA testing system, the BERT sends test data patterns to the optical transmitter and receives return data from the test circuit 104.

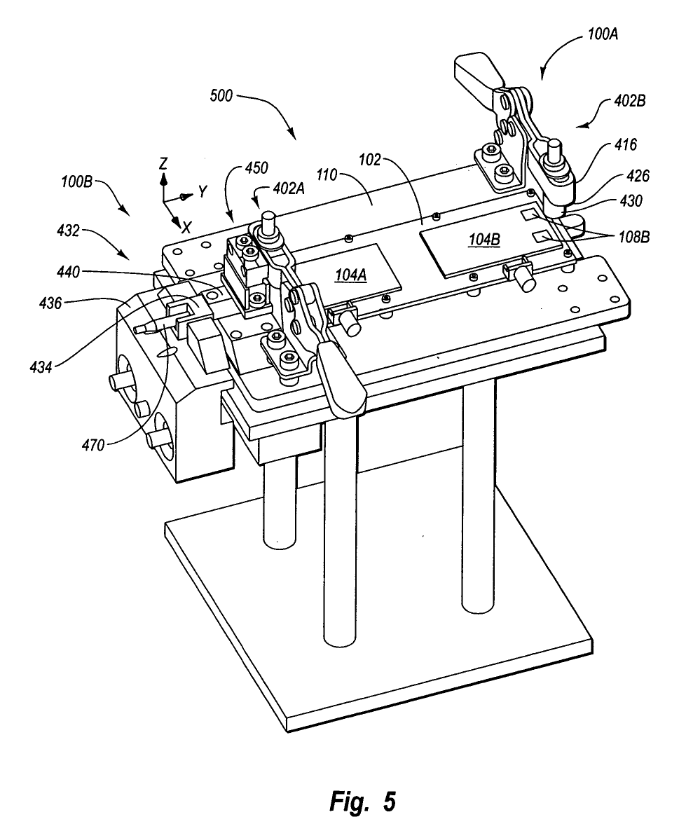

With reference to FIG. 5, a perspective view of an exemplary testing assembly 500 is shown. FIG. 5 illustrates a dual testing configuration having a first testing assembly 100A and a second testing assembly 100B located on opposing ends of the same base member 110. The base member 110 includes a printed circuit board 102 having test circuitry 104A, 104B disposed thereon. Testing assembly 100A thus includes a portion of base member 110, a portion of printed circuit board 102, test circuitry 104A, clamping assembly 402A, mounting assembly 432 and thermal transfer assembly 450. Testing assembly 100B includes a portion of base member 100, a portion of printed circuit board 102, test circuitry 104B, electrical interface 108B, clamping assembly 402B and a mounting assembly (not shown). It will be appreciated that electrical interface 108B can be formed from any suitable connection means, for example, bonding pads, which can electrically communicate with corresponding electrical contacts on the end of a flexible circuit.

The dual testing assembly configuration illustrated in FIG. 5 enables a user with increased flexibility regarding testing of optical subassemblies. In one embodiment, the dual testing assembly configuration can be configured so that the printed circuit board 102 has test circuitry 104A and 104B that provides an operator various testing capabilities. For example, test circuitry 104A and 104B can be the same so that an operator can test two optical subassemblies (e.g., two TOSAs) at the same time for the same operating parameter. Alternatively, test circuitry 104A and 104B can be configured to provide different tests at each end. In this manner, for example, an operator can test a first optical subassembly (e.g., TOSA) at test assembly 100A while testing a different optical subassembly (e.g., ROSA) at test assembly 100B. In still another configuration, test circuitry 104A and 104B can be configured to allow an operator to perform different tests on the same optical subassembly at different ends of the testing board. For example, the user can test a TOSA at the first test assembly 100A for a particular operating requirement, and can subsequently test the same TOSA for a different operating requirement at the second testing assembly 100B. It will further be appreciated that the test circuitry 104A and 104B can be configured to communicate with each other so that, for example, the same optical subassembly can be tested at a TOSA on one end and a ROSA on the other end. In still another embodiment, test circuitry 104A and 104B could be combined to form circuitry that simulates true performance in an optical subassembly module.

In other configurations, the test assemblies 100A, 100B may be placed orthogonal to each other and more than two testing assemblies 100 may be disposed on the same base. For example, a testing assembly could be placed on each side of a four-sided base. In addition, the printed circuit board 102 can be discretely configured to correspond to a single testing assembly 100. Furthermore, it will be appreciated that the clamping assemblies 402A, 402B may be mounted on either side of base member 110 to accommodate left-handed or right-handed preferences of the operator. It will be appreciated that the configuration and placement of test circuitry 104A and/or 104B may vary depending on the particular testing desired, and that various configurations are possible in view of the teachings herein.

Yet another feature of testing assembly 500 includes a means for aligning the optical subassembly over the test circuit 108. In one embodiment, the means for aligning the optical subassembly includes a mounting assembly 432 connected to the base 110. The mounting assembly 432 serves the dual purpose of engaging the optical subassembly to securely mount it during the testing procedure and also aligning the optical subassembly in the proper position. Although not shown, the mounting assembly 432 can be positioned relative to base 110 by means of x and y stages, dowel pins, incremental screw advancers, hydraulic or pneumatic mechanisms, or other mechanisms which allow the mounting assembly to move in potentially three dimensions. Thus, when the optical subassembly is engaged by the mounting assembly 432, the mounting assembly can be moved to place the optical subassembly in the correct position over the electrical interface 108. The details of mounting assembly 432 are described further below.

With reference still to FIG. 5, in one configuration, the testing assembly 500 can have a first testing assembly 100A to test an optical subassembly at a first temperature while the second testing assembly 100B can be configured to test the optical subassembly at a higher or lower temperature than the temperature of the first testing assembly 100A. In one configuration, the testing assembly 100A can be configured to test an optical subassembly at ambient temperature while the testing assembly 100B tests that same optical subassembly at higher or lower temperature than ambient temperature. Thus, the term “lower temperature” may mean lower than ambient temperature or could also mean lower than the temperature at which the optical subassembly was first tested. Similarly, the term “higher temperature” may mean higher than ambient temperature or could also mean higher than the temperature at which the optical subassembly was first tested.

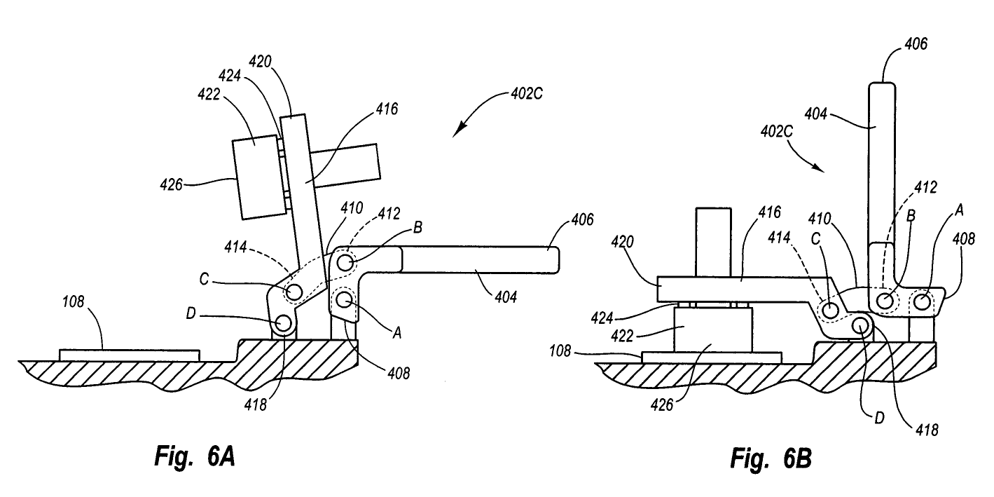

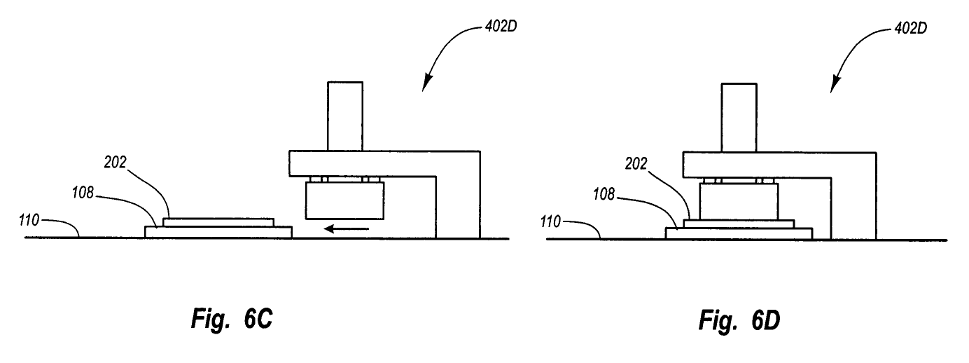

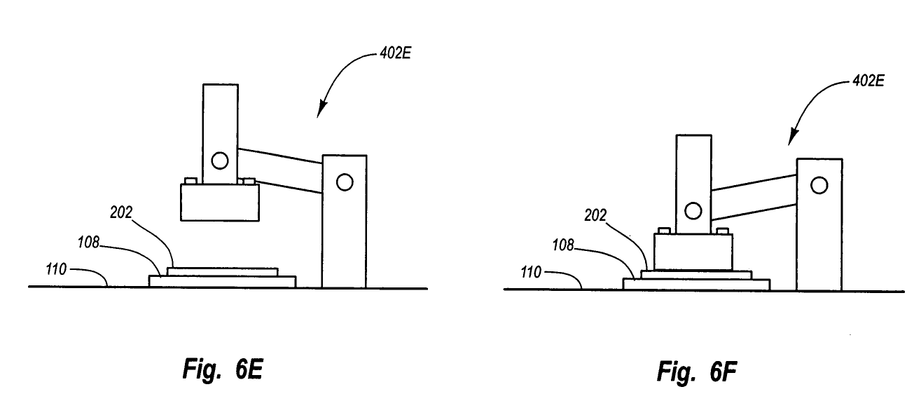

With reference to FIGS. 6A through 6F, an exemplary clamping assembly 402C will be described in further detail. Depicted in FIG. 6A is a schematic drawing of a clamping assembly 402C pivotably mounted on the base member 110. FIG. 6A illustrates the clamp assembly 402C in the open or unengaged position and FIG. 6B illustrates the clamp assembly 402C in the closed or engaged position. 402C.

The base member (e.g., numeral 110 in FIG. 1) is configured to receive a PCB (e.g., numeral 102 in FIG. 1) containing a test circuit (e.g., numeral 104 in FIG. 1) with an electrical interface 108. Although not shown, the PCB may be secured to the base member with fastening devices such as screws or spring-loaded pegs. The base member itself may also be secured to a work surface directly or via multiple legs, for example.

The clamping assembly 402C includes a lever 404, a link member 410, a a head member 416 and a clamping member 422. The combined movement of these four members creates a clamping action characterized by two distinct clamping positions. The first position creates a moderate clamping force. The second position, also called the closed position, applied by adding more force to the clamping assembly, creates a greater clamping force than the first position and acts to temporarily lock the clamp in place. In a preferred embodiment, the clamping assembly 402C “snaps” into the second position, and stably remains in the second position after it is achieved.

The lever 404 has a first end 406 and a second end 408 and is in the form of an “L” with the long “L” side being at the first end and the short “L” side being at the second end. The first end 406 is configured to rotate by means of pressure applied by the human hand or other mechanical means. Second end 408 of lever 404 is pivotably connected to base member 110 at a first pivot joint A. That is, second end 408 of lever 404 and base member 110 preferably include apertures which are configured to cooperate to receive a pin through the apertures. Second end 408 of lever 404 is also pivotably connected to link member 410 at second pivot joint B. That is, second end 408 of lever 404 and link member 410 include apertures which are configured to cooperate to receive a pin therethrough.

The link member 410 has a first end 412 and a second end 414. The first end 412 includes an aperture formed transversely therethrough and configured to receive a pin therethrough to form a pivot joint with the lever 404, as mentioned above. The second end 414 of link member 410 is configured to be pivotably connected to head member 416 at third pivot point C. That is, second end 414 of link member 410 and head member 416 have apertures formed transversely therethrough and cooperating to receive a pin to pivotably connect the two members.

The head member 416 has a first end 418 and a second end 420 and has a shape similar to the letter “Z.” The bend in the “Z” has an aperture formed transversely therethrough and configured to receive a pin therethrough to form pivot point C, as mentioned above. In addition, head member 416 is pivotably connected to base member 110 at fourth pivot point D. That is, the far end of first end 418 includes an aperture formed transversely therethrough which cooperates with a corresponding aperture in base member 110 to receive a pin therethrough to form a pivot joint between the link member 410 and the head member 416, as mentioned above. Finally, the second end 420 of head member 416 is configured to receive at least one pin therethrough to form a perpendicular junction between the head member 416 and the clamping member 422.

The clamping member 422 has a first end 424 and a second end 426. The first end 424 is configured to receive at least one pin therethrough to form a perpendicular junction between the head member 416 and the clamping member 422, as mentioned above. As shown more clearly in FIGS. 6C through 6F, the second end 426 has a planar surface to facilitate clamping a flex circuit 202 to the electrical interface 108 when the clamp assembly 402C is in the closed or engaged position, thereby forming a temporary high quality electrical connection. The flexible circuit 202 is, in turn, attached to an optical component (not shown) being tested.

The clamping assembly 402C thus provides a four-bar linkage or trapezoidal pivot assembly formed by pivot points A, B, C and D. Pivot points A and D connect the clamping assembly 402C to base member 110 while pivot points B and C translate movement from lever 404 to head member 416 via link member 410. Operation of lever 404 from the unengaged position thus moves the clamping member 422 into a first position to provide a moderate clamping force. Applying additional force to lever 404 moves the clamping member 422 into a second position or closed position. The second position creates a greater clamping force serving to temporarily lock the clamp member 422 in place. In a preferred embodiment, the clamping assembly 402C “snaps” into the second position, and stably remains in the second position after it is achieved.

While clamping assembly 402C has been described as four discrete parts, the clamping assembly may also include more or fewer members while still creating the temporary high quality electrical connection described above. In addition, other means may be provided for forming the pivotal connection between the members of the clamping assembly 402C and base member 110 other than a pivot and pin connection as will be understood by those skilled in the art in light of this specification.

Still other means are provided for placing the optical component of the optical subassembly in temporary electrical connection with the testing assemblies of the present invention. FIGS. 6C and 6D illustrate another embodiment where the clamping assembly 402D is slidably coupled to base member 110 such that it moves between an engaged and unengaged position. In the unengaged position, the clamping. assembly 402D is positioned away from electrical interface 108. In the engaged position, flexible circuit 202 has been disposed on or at electrical interface 108. Clamping assembly 402D is moved inward to be disposed over the flexible circuit 202. In this embodiment, the electrical interface 108 should be configured so that it does not. affect the end of the flexible circuit 202 during the sliding action.

The clamping assembly 402D may provide a two-step clamping assembly. When it is slid over the electrical interface 108, it may provide a moderate clamping force again flexible circuit 202 onto the electrical interface 108. Additional mechanisms may be provided to provide a second, stronger clamping force which causes flexible circuit 202 to strongly be compressed against electrical interface 108. Alternatively, a one-step sliding movement may be sufficient to place the clamping assembly in contact with electrical interface 108.

FIGS. 6E and 6F illustrate another means for providing a temporary electrical connection between flexible circuit 202 and electrical interface 108. In this embodiment, the clamping assembly 402E is disposed above the electrical interface 108, leaving room for flexible circuit 202 to be disposed on electrical interface 108. Mechanisms are provided for bringing the clamping assembly 402E down onto the flexible circuit 202 and providing a strong clamping force to place the flexible circuit in electrical contact with electrical interface 108. Again, the clamping force may be provided in a two-step mechanism which provides a moderate and a strong clamping force.

When the optical component already has a flex circuit bonded to the connection end, the temporary connection may be created by mechanically pressing the bonding pads or electrical connection of the flex circuit to the electrical interface on the test circuit. Magnets, pressure fixtures, screws or other clamping mechanisms are used to help make a secure, temporary connection. Advantageously, the test board and clamping assembly provide a high quality electrical connection between the optical subassembly and the test board without using solder or other permanent connection means.

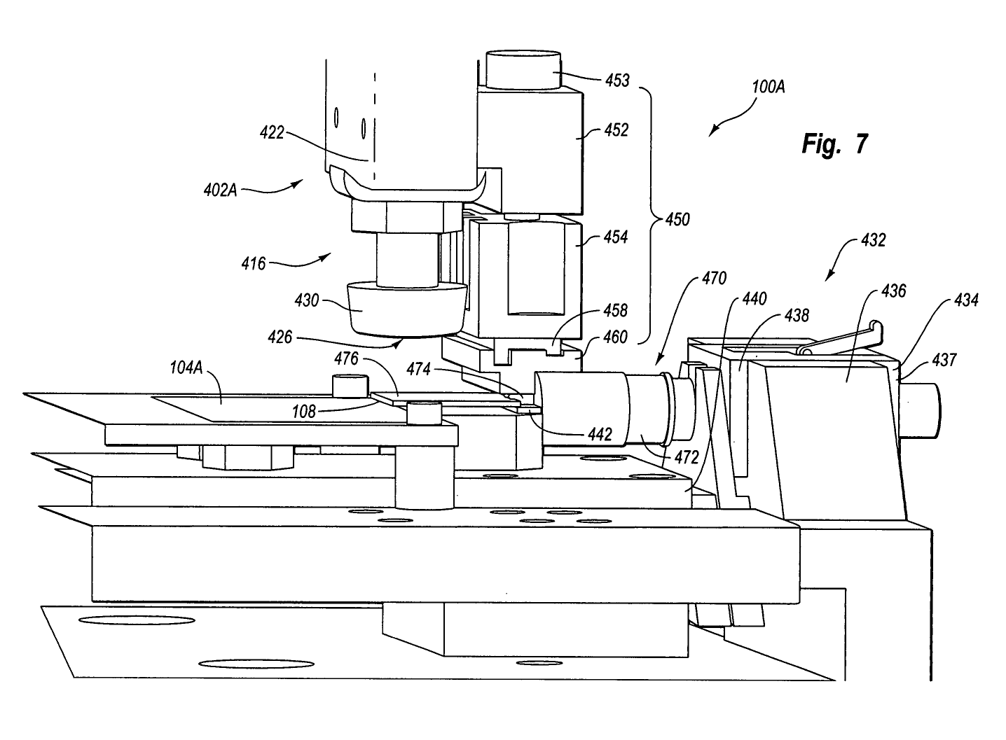

As shown in FIG. 7, clamping assembly 402A is shown in greater detail. FIG. 7 shows that second end 426 of the head member 416 can include a resilient member 430. The resilient member 430 can include nonconductive rubber or other elastomeric or compliant material such as, but not limited to, springs, foam, and the like. Resilient member 430 should be a nonconductive material so as not to short the flexible circuit which is placed in contact with the resilient member. The resilient member 430 assists in providing the two-level clamping force described above. Specifically, the resilient member 430 allows a high level of clamping force, but contains a sufficient amount of resiliency so that components of the testing assembly and/or optical subassembly are not damaged. Additionally, a vacuum source (not shown) may be provided to hold down the end of the flexible circuit.

In addition, FIG. 7 illustrates one configuration for a means for temporarily placing the optical subassembly in thermal communication or contact with the thermal transfer assembly. FIG. 7 illustrates one embodiment of associating the thermal transfer assembly 450 with the base member 110 via clamping assembly 402A so as to be able to be thermally coupled with the optical subassembly 470. Note that the embodiment of FIG. 7 is only one possible configuration for associating the thermal transfer assembly 450 with the base member 110.

In the configuration of FIG. 7, the thermal transfer assembly 450 is coupled to the clamping assembly 402A. The thermal transfer assembly 450 is attached to the clamping member 422 of the clamping assembly 402A so that it is capable of being thermally coupled to an optical subassembly 470. In use, the optical subassembly 470 could be tested at ambient temperature with the thermal transfer assembly 450 being disabled and subsequently tested at higher or lower temperatures with the thermoelectric cooler portion 458 being operational.

In one embodiment, the thermal transfer assembly 450 includes a connecting portion 452, a heat sink 454, a thermoelectric cooler 458 and a conductive member 460. The connecting portion 452 is connected to the clamping member 422 of clamping assembly 402A via screws or bolts or other connecting means. In one embodiment, the connecting means are a pair of vertical shoulder screws 453 coupling the connecting portion 452 to the heat sink 454. The shoulder screws 453 may have a pair of springs (not shown) disposed therethrough. As such, the movement of the clamping assembly 402B is translated to the thermal transfer assembly 450 so that both can be brought into contact with the optical subassembly 470. In one embodiment, both are brought into contact with the optical subassembly 470 at substantially the same time. The connecting portion 452 may be constructed of any material (e.g., metal or plastic) which provides sufficient strength to connect to the clamping assembly. In one embodiment, the connecting portion 452 may be constructed of conductive material to assist in serving a heat sink capacity. That is, heat transmitted to the heat sink 454 can be additionally dissipated by the connecting portion 452.

Below the connecting portion 452 is a heat sink 454. Heat sink 454 is primarily required where the thermoelectric cooler acts as a cooler in order to dissipate heat away from the hot face of the thermoelectric cooler. However, the heat sink 454 may also be present where the thermoelectric cooler acts as a heater. Preferably, the heat sink 454 is constructed with fins which assist to dissipate heat into the atmosphere therearound. The heat sink 454 is constructed of a material (e.g., metal) which is able to withstand high temperatures and also cold temperatures and is also highly thermally conductive. A fan or other air source (not shown) may also be provided to assist in dissipating heat from the heat sink 454.

The heat sink 454 also provides some degree of flexibility between the thermal transfer assembly 450 and the optical subassembly 470. Thus, the thermoelectric cooler does not have to be perfectly positioned, centered or otherwise, while still allowing the thermal transfer assembly 450 to come into sufficient contact with at least a portion of the optical subassembly. Otherwise, if the thermal transfer assembly 450 were completely rigid, both the thermoelectric cooler and optical subassembly have the potential of breaking if one or the other is off-center when brought into contact. In one embodiment, the heat sink 454 is a conductive metal having the resilient functionality provided by springs (not shown) disposed in shoulder screws 453. The conductive metal could be copper, copper alloy, aluminum, or any other thermally conductive material. In another embodiment, the resilient functionality may be provided by placing a soft thermally conductive material in the form of a pad or paste between the thermoelectric cooler 458 and the conductive member 460 which provides a degree of resiliency therebetween. An example of the soft thermally conductive material is Gap Pad® VO Ultra Soft.

The thermoelectric cooler 458 is disposed between the heat sink 454 and the conductive member 460. The thermoelectric cooler 458 may have one of various configurations, but generally includes a top face, a bottom face, and a plurality of thermoelectric elements disposed between the top face and the bottom face. The thermoelectric elements are positioned in series and parallel so that a current can run through the matrix of thermoelectric elements and cause heating on one of the top or bottom face and a cooling effect on the other. Preferably, the thermoelectric cooler 458 can be both a cooler and a heater. That is, the bottom face can both be heated to a high temperature or cooled to a low temperature. The thermoelectric cooler 458 may be a single thermoelectric cooler module or a cascade thermoelectric cooler module.

A conductive member 460 is connected to the bottom face of the thermoelectric cooler 458. The conductive member 460 is configured to come into contact with at least a portion of the optical subassembly and conduct the heating or cooling thereto. The conductive member 460 is thus constructed of a suitable conductive material (e.g., copper). The bottom face of the conductive member 460 is preferably configured to be complementary to the optical subassembly, as shown in FIG. 5. As discussed above, the thermoelectric cooler 458 is disposed above the conductive member 460. In one embodiment, the conductive member 460 can be constructed as the bottom face of the thermoelectric cooler 458. In some embodiments, it is possible for conductive member 460 not to actually contact the optical subassembly. It could be placed within close proximity of the optical subassembly with a small amount of air therebetween. Alternatively, a conductive materials, e.g., Gap Pad® VO Ultra Soft can be placed between the conductive member 460 and the optical subassembly.

A thermistor (not shown) reads the temperature of the conductive member 460 to determine whether the thermoelectric cooler 458 should be heated or cooled. The temperature range of the thermoelectric cooler 458 depends on the material of the thermoelectric elements and the amount of current running through the elements.

In one embodiment, the thermoelectric cooler 458 can cool down to about 0° C. and heat up to about 70° C. In another embodiment, the cooling and heating effect ranges from about 85° C. to about negative (−)40° C. In still another embodiment, the cooling and heating effect is from about 125° C. to about negative (−)55° C. In some applications it even possible to heat or cool the optical subassembly above (e.g., up to 200° C.) or below these ranges.

Of course the extent to which the optical subassembly 470 can be heated or cooled depends on various design parameters such as the type of thermoelectric cooler 458, the environment in which testing occurs, the maximum amount of power that can be delivered to the thermoelectric cooler 458, and the amount of heat that the optical subassembly generates during testing. In some embodiments, it may be required to cascade the thermoelectric cooler 458 by stacking more than one thermoelectric cooler onto each other to generate more heat or greater cooling. In yet another embodiment, the thermoelectric cooler 458 may be configured to be only a heater, i.e., to only be heated above ambient temperature. In embodiments where thermoelectric cooler 458 is configured to cool to extremely low temperatures, condensation of moisture may be prevented by providing an environment that is purged with nitrogen (N₂) or Clean Dry Air (CDA).

The thermal transfer assembly 450 can thus be configured to heat or cool any portion of an optical subassembly. The thermoelectric cooler 458 can be placed in thermal contact with at least a portion of the optical subassembly. This may be done by placing the thermal transfer assembly 450 in direct contact with components or in contact with the housing of the optical subassembly in order to heat the inside of the housing and immediate surroundings.

FIGS. 5 and 7 also illustrate the thermal coupling of thermal transfer assembly 450 with an optical subassembly 470. It will be appreciated that various types of optical subassemblies may be used and that the embodiment shown in FIGS. 5 and 7 is provided for the purpose of illustration only. Optical subassembly 470 includes a cylindrical housing 472 and a ceramic platform 474 disposed perpendicularly through the end of the housing 472. The ceramic platform 474 is configured to have an optical device (e.g., lasers, transistors, resistors, capacitors, etc.) disposed thereon. The optical subassembly 470 includes a flex circuit 476 connected to the end of the ceramic base 474. The other end of the flex circuit 476 is left freely hanging until it is permanently connected to the electrical portion of the optoelectronic device. Further details of optical subassembly 470 are disclosed in U.S. Pat. No. 6,586,678, filed Feb. 14, 2002, and entitled “Ceramic Header Assembly,” which application is incorporated herein by reference in its entirety.

As shown in FIG. 5, the optical subassembly 470 is coupled to mounting assembly 432. Specifically, mounting assembly 432 includes a fiber connector portion 434 which secures the housing 472 of the optical subassembly 470. The fiber connector portion 434 can be similar to a portion of the optical device to which the optical subassembly is attached. For example, an outward portion 437 can include an LC connector to which the optical subassembly 470 can couple. An inward portion 438 can form an adaptor portion to hold the nose of the optical subassembly 470 with an end of the housing 472 disposed therethrough. In one embodiment, the fiber connector portion 434 can be removable from advancing portion 436 (discussed below) so that an operator can placed the optical subassembly 470 therein before attaching it to the rest of the mounting assembly 432. In other configurations, however, the fiber connector portion 434 can be fixedly attached to the mounting assembly 432.

The mounting assembly 432 also includes an advancing portion 436. FIG. 7 shows the fiber connector portion 434 configured to attach to the advancing portion 436 so that the optical subassembly 470 can be moved by the mounting assembly. The mounting assembly 432 can be positioned in the x, y or z directions to place the housing of the optical subassembly 470 in the desired testing position. That is, the advancing portion 436 moves in the y direction and a sliding plate 440 can move in the x direction. Although not shown, the mounting assembly 432 can also be configured to move in the z direction. A block 440 can be provided underneath the optical subassembly 470 for registering when an optical subassembly is placed in testing assembly 500.

In one exemplary method of testing an optical subassembly 470, the method includes electrically coupling the optical subassembly 470 to the test circuit 108. With reference to FIG. 7, this can generally include the following: First, the ceramic base 474 protruding from the housing 472 is placed over a support 442. One end of the flexible circuit 476 is connected to the ceramic base 474. The other free-hanging end is disposed over the electrical interface 108 of the testing assembly 100B. The clamping assembly 402A is then actuated so as to place the flexible circuit 476 in direct contact with the electrical interface 108. The ceramic base 474 will usually include electrical structures (e.g., leads, traces, electrical pads, flexible circuits) which place the optical subassembly 470 in electrical communication with the electrical interface 108 through flexible circuit 476. The electrical interface 108 can include corresponding electrical structures (e.g., leads, traces, electrical pads) to electrically connect to the flexible circuit 476. For example, as shown in FIG. 7, one end of the flex circuit 476 is placed over the electrical interface 108. This places electrical structures on the ceramic base 474 and other electrical structures inside housing 472 in electrical communication with test circuit 104 (see FIG. 1).

In addition, thermally coupling the thermal transfer assembly 450 to the optical subassembly 470 can include placing the thermal transfer assembly 450 in direct contact with ceramic base 474 and/or housing 472. However, the thermal transfer assembly 450 can contact any portion of the optical subassembly 470 as desired. As discussed above, the conductive member 460 can be shaped to better engage the surfaces of the ceramic base 474 and/or housing 472. For example, where the housing 472 is substantially cylindrical, the conductive member 460 may also be curved so that a greater surface area of the conductive member comes in contact with the housing. The conductive member 460, however, can be shaped according to any optical subassembly to be tested.

Furthermore, the thermal transfer assembly 450 need not actually contact any portion of the optical subassembly in order to be “thermally coupled” thereto. It is sufficient that the thermoelectric adjustment assembly 450 be close enough to the optical subassembly 470 to affect heating or cooling without heating or cooling a significant portion of the surrounding testing assembly 100B. However, it may be beneficial to have the thermal transfer assembly 450 actually contact the optical subassembly 470 so that the operator ensures thermal coupling. Maximizing the heat transfer between the thermal transfer assembly 450 and the optical subassembly 470 can produce the minimal amount of wasted energy and reduce the amount of testing time.

After the thermal transfer assembly 450 is thermally coupled with the optical subassembly 470, the optical subassembly can be tested at ambient temperature by keeping the thermoelectric cooler 458 inoperable. After testing the optical subassembly at ambient temperature, the thermal transfer assembly 450 can be operated to heat or cool the optical subassembly 470. The heated or cooled optical subassembly 470 is then tested at the higher or lower temperature.

FIGS. 5 and 7 illustrate one embodiment for locally heating or cooling the optical subassembly without significantly heating or cooling other components of the testing assembly 100. While the heat transfer between the thermal transfer assembly 450 and optical subassembly 470 is maximized, it is desirable to minimize the heat transfer between the thermal transfer assembly 450 and other components of testing assembly 100. The base member 110 and the optical subassembly 470 are preferably positioned in relation to each other so as to minimize the heat flow therebetween. In addition, the thermal transfer assembly 450 is positioned in relation with the base member 110 so as to minimize the heat flow therebetween. Note that in FIGS. 5 and 7, the thermoelectric cooler 458 is in effect suspended away from other components of the testing assembly 100 so that it only comes in contact with the optical subassembly 470.

In another embodiment, not shown, the thermal transfer assembly 450 may be associated with the base member 110 by a separate clamping mechanism which raises and lowers the thermal transfer assembly 450 to come into thermal contact with the optical subassembly. In still another embodiment, the thermal transfer assembly 450 may be placed on a base member that is separate from base member 110, but placed in proximity with the optical subassembly so that it can be placed in thermal contact therewith.

In one configuration, the thermal transfer assembly 450 may include a shield (not shown) around at least a portion thereof to keep heat in the localized area around the optical subassembly 470 and to prevent air turbulence from significantly adjusting the desired temperature. However, in other configurations a shield is not required since the thermoelectric cooler 458 is generally larger than the component of the optical subassembly with which it comes in contact so that there is generally enough heating or cooling from the thermoelectric cooler to achieve the desired temperature.

Further, the components around that hold the optical subassembly and/or flexible circuit that do not have a conductive function can be constructed from material that minimizes heat transfer through these nonconductive components. For example, printed circuit board 102 could be constructed from a nonthermally conductive material such as FR4 fiberglass or G10 materials or other nonconductive plastic materials. In this way, heating or cooling can be more efficiently concentrated toward the optical subassembly.

In another embodiment, heating of the optical subassembly 470 can occur without using thermal transfer assembly 450. In one embodiment, the optical subassembly 470 can be temporarily connected to appropriate electrical components such that the optical subassembly 470 is operable. For example, as discussed above, test circuitry 104A and 104B shown in FIG. 5 can be configured to simulate actual performance in the optical subassembly. While running the optical subassembly 470, it could be allowed to heat without assistance from other external structures. The optical subassembly 470 could then be tested at various temperatures as it heats, with final testing done at the maximum temperature that it reaches during simulated operation.

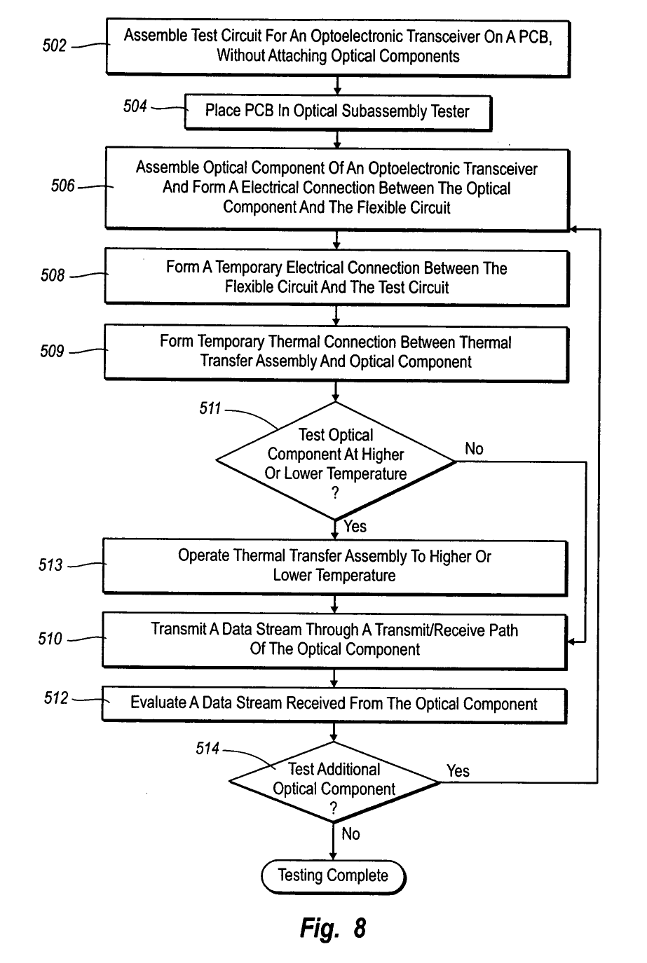

FIG. 8 is a flowchart of one exemplary method in which the optical subassembly tester may be used to test the optical component 470 (i.e., TOSA 204 or ROSA 302) of an optoelectronic device. At step 502, to test an optical component of an optoelectronic device, a test circuit 104 is assembled. The test circuit 104 is formed on a PCB 102 and is configured to transmit or receive test signals to and from the host computer 114 and to be electrically coupled to an optical component at an electrical interface 108. At step 504, the PCB 102 containing the test circuit is then placed, and preferably secured, on the base member 110 of the optical assembly tester 100.

At step 506, the optical component is assembled and a high quality electrical connection, preferably a soldered connection, is formed between the optical component and a flex circuit 202. This optical component, if joined with a complimentary optical component (i.e., a ROSA with a TOSA) and an electrical component, would form the internal components of an optoelectronic device. For the present invention, however, the goal is to test an optoelectronic device's optical component before it is joined with the remaining optoelectronic device components.

At step 508, the flex circuit 202, which is attached to the optical component, is placed in contact with the electrical interface of the test circuit 104 formed on the PCB 102 and a clamp assembly 106 is closed to form a temporary high quality electrical connection. At step 509, the thermal transfer assembly 450 is temporarily thermally connected to the optical component. At step 511, a determination is made by the operator to test the optical component at a higher or lower temperature. If the operator wishes to test the optical component at ambient temperature, then the process proceeds to step 510. If the operator wishes to test the optical component at a higher or lower temperature, at step 513, the host computer can control the thermal transfer assembly to increase or decrease in temperature so as to corresponding heat or cool the optical component. The process then proceeds to step 510.

At step 510, a data stream is then transmitted through a transmit/receive path of the optical component, and a resulting data stream is received from the optical component. At step 512, this received data stream is evaluated to determine whether the optical component is functioning properly. Step 514 indicates that steps 506, 508, 509, 511, 513, 510 and/or 512 may then be repeated in order to test additional optical components. It will be appreciated that some steps may be performed out of the order identified above. For example, the optical component may first be assembled before assembling the tester. Another example might be that the thermal transfer assembly is thermally coupled to the optical component before the optical component is electrically connected to the test circuit.

When the optical component to be tested is a receiver optical subassembly (ROSA), an optical signal is sent to the optical input port of the ROSA. If the ROSA is at least partially functional and all necessary connections in the signal path are functional, the ROSA converts the optical signal into an electrical signal, which is then conveyed to a tester or other evaluation device. The electrical signal is evaluated to detect any errors that may indicate a malfunctioning optical component.

When the optical component to be tested is a transmitter optical subassembly (TOSA), an electrical signal is sent to the electrical input port of the TOSA. If the TOSA is at least partially functional and all necessary connections in the signal path are functional, the TOSA converts the electrical signal into an optical signal, which is then conveyed to a tester or other evaluation device. The optical signal is evaluated to detect any errors that may indicate a malfunctioning optical component.

The test assemblies of the present invention enable full data rate testing of the optical subassembly, typically at data rates, such as 155 MHz, 1 Gb/s, 10 Gb/s, and 40 Gb/s, as opposed to the simple dead/alive, voltage/current tests performed in the past on optical subassemblies prior to assembly with the device electronics. By testing the optical subassemblies separately from the device electronics, the majority of device failures are detected prior to assembly of the optical subassemblies with the device electronics, thereby greatly reducing the manufacturing costs associated with such failures.

Some aspects of the present invention can be implemented as a computer program product that includes a computer program mechanism embedded in a computer readable storage medium. For instance, the computer program product could contain the program modules contained in the host computer 114 (FIGS. 1-4). These program modules may be stored on a CD-ROM, disk storage product, or any other computer readable data or program storage product. The software modules in the computer program product may also be distributed electronically, via the Internet or otherwise, by transmission of a computer data signal (in which the software modules are embedded) on a carrier wave.

Preferred embodiments of the invention are described above. In the interest of clarity, not all features of an actual implementation are described. It will be appreciated that in the development of any such embodiment, numerous implementation-specific decisions must be made to achieve the developers' specific goals, such as compliance with system-related and business-related constraints, which will vary from one implementation to another.

Moreover, it will be appreciated that such a development effort might be complex and time-consuming, but would nevertheless be a routine undertaking for those of ordinary skill in the art having the benefit of this disclosure.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method of testing an optical subassembly (“OSA”) of an optoelectronic device, comprising:
identifying a testing assembly comprising a base assembly, the base assembly being associated with a thermal transfer assembly;
identifying an optical subassembly;
temporarily electrically coupling the base assembly and the optical subassembly;
temporarily thermally coupling the thermal transfer assembly and the optical subassembly;
transferring heat between the thermal transfer assembly and the optical subassembly so as to adjust the temperature of the optical subassembly while substantially maintaining the temperature of the base assembly; and
testing the optical subassembly at the adjusted temperature for a first operating parameter.

2. The method as recited in claim 1, wherein temporarily thermally coupling the thermal transfer assembly and the optical subassembly comprises maximizing the heat flow between the thermal transfer assembly and the optical subassembly.

3. The method as recited in claim 1, further comprising positioning the base assembly with respect to the optical subassembly so as to minimize the heat flow between the base assembly and the optical subassembly.

4. The method as recited in claim 1, further comprising positioning the thermal transfer assembly with respect to the base assembly so as to minimize the heat flow between the thermal transfer assembly and the base assembly.

5. The method as recited in claim 1, wherein the optical subassembly is one of a transmitter optical subassembly (“TOSA”) and a receiver optical subassembly (“ROSA”).

6. The method as recited in claim 1, wherein transferring heat between the thermal transfer assembly and the optical subassembly so as to adjust the temperature of the optical subassembly while substantially maintaining the temperature of the base assembly comprises adjusting the temperature higher than ambient temperature.

7. The method as recited in claim 6, wherein the temperature of the optical subassembly can be adjusted up to about 70° C.

8. The method as recited in claim 6, wherein the temperature of the optical subassembly can be adjusted above 70° C.

9. The method as recited in claim 1, wherein transferring heat between the thermal transfer assembly and the optical subassembly so as to adjust the temperature of the optical subassembly while substantially maintaining the temperature of the base assembly comprises adjusting the temperature lower than ambient temperature.

10. The method as recited in claim 9, wherein the temperature of the optical subassembly can be adjusted down to about −40° C.

11. The method as recited in claim 9, wherein the temperature of the optical subassembly can be adjusted below −40° C.

12. A testing assembly configured to evaluate an optical subassembly before the optical subassembly is connected to electrical components of an optoelectronic device, the assembly comprising:
a base member;
a test circuit disposed on the base member;
means for temporarily placing the optical subassembly in electrical communication with the test circuit; and
a thermal transfer assembly associated with the base member, the thermal transfer assembly configured to adjust the temperature of a portion of the optical subassembly, the thermal transfer assembly comprising means for temporarily placing the optical subassembly in thermal communication with the thermal transfer assembly.

13. The testing assembly as recited in claim 12, wherein the means for temporarily placing the optical subassembly in electrical communication with the test circuit comprises a clamping assembly coupled to the base member for placing a flexible circuit of an optical subassembly in electrical communication with the test circuit.

14. The testing assembly as recited in claim 12, wherein the means for temporarily placing the optical subassembly in electrical communication with the test circuit comprises a mounting assembly for positioning the optical subassembly relative to the base member.

15. The testing assembly as recited in claim 12, wherein the means for temporarily placing the optical subassembly in thermal communication with the thermal transfer assembly comprises a thermoelectric cooler assembly.

16. The testing assembly as recited in claim 12, wherein the thermal transfer assembly is coupled to the means for temporarily placing the optical subassembly in electrical communication with the test circuit.

17. The testing assembly as recited in claim 12, wherein the means for temporarily placing the optical subassembly in thermal communication with the thermal transfer assembly is configured to adjust the temperature of the optical subassembly higher than ambient temperature while substantially maintaining the temperature of the base assembly.

18. The testing assembly as recited in claim 17, wherein the temperature of the optical subassembly can be adjusted to about 70° C.

19. The method as recited in claim 17, wherein the temperature of the optical subassembly can be adjusted to above 70° C.

20. The method as recited in claim 12, wherein the means for temporarily placing the optical subassembly in thermal communication with the thermal transfer assembly is configured to adjust the temperature of the optical subassembly below ambient temperature while substantially maintaining the temperature of the base assembly.

21. The method as recited in claim 20, wherein the temperature of the optical subassembly can be adjusted down to about −40° C.

22. The method as recited in claim 20, wherein the temperature of the optical subassembly can be adjusted below −40° C.

23. The testing assembly as recited in claim 12, wherein the optical subassembly is one of a transmitter optical subassembly (“TOSA”) and a receiver optical assembly (“ROSA”).

24. A testing assembly configured to evaluate an optical subassembly before the optical subassembly is connected to electrical components of an optoelectronic device, the assembly comprising:
a base member;
a test circuit disposed on the base member;
a clamping assembly mounted to the base member, the clamping assembly configured to place the optical subassembly in temporary electrical communication with the test circuit; and
a thermal transfer assembly mounted to the clamping assembly, the thermal transfer assembly configured to be temporarily thermally coupled to an optical subassembly and to temporarily adjust the temperature of a portion of the optical subassembly.

25. The testing assembly as recited in claim 24, wherein the clamping assembly is pivotably coupled to the base member.

26. The testing assembly as recited in claim 24, wherein the thermal transfer assembly comprises:
a connector portion configured to at least indirectly coupled the thermal transfer assembly to the base member; and
a thermoelectric cooler.

27. The testing assembly as recited in claim 26, wherein the connector portion is coupled to the clamping assembly.

28. The testing assembly as recited in claim 26, further comprising a resilient member for allowing the thermoelectric cooler to come into contact with the portion of the optical subassembly.

29. The testing assembly as recited in claim 24, further comprising a mounting assembly configured to selectively couple the optical subassembly and position the optical subassembly in relation to the base assembly.

30. The testing assembly as recited in claim 24, wherein the thermal transfer assembly is configured to adjust the temperature of the optical subassembly higher than ambient temperature while substantially maintaining the temperature of the base assembly.

31. The testing assembly as recited in claim 30, wherein the temperature of the optical subassembly can be adjusted to about 70° C.

32. The method as recited in claim 30, wherein the temperature of the optical subassembly can be adjusted to above 70° C.

33. The method as recited in claim 24, wherein the thermal transfer assembly is configured to adjust the temperature of the optical subassembly below ambient temperature while substantially maintaining the temperature of the base assembly.

34. The method as recited in claim 33, wherein the temperature of the optical subassembly can be adjusted down to about −40° C.

35. The method as recited in claim 33, wherein the temperature of the optical subassembly can be adjusted below −40° C.

36. The testing assembly as recited in claim 24, wherein the optical subassembly is one of a transmitter optical subassembly (“TOSA”) and a receiver optical assembly (“ROSA”).
